(19) United States
(12) Patent Application Publication
(10) Pub. No.: US 2026/0105487 A1
(43) Pub. Date: Apr. 16, 2026

(54) SYSTEM AND METHOD FOR DETERMINING CROSS-PLATFORM REACH

(71) Applicant: NBCUniversal Media, LLC, New York, NY (US)

(72) Inventors: Anna Wysocki, Brooklyn, NY (US); Kumar Nagaraja rao, Broadlands, VA (US); Robert Davis, Dingmans Ferry, PA (US); Daniel Mayerhofer, Hopewell Junction, NY (US); Thomas J. Barr, Melbourne, FL (US); Alison Soong, Irvington, NY (US)

(21) Appl. No.: 19/356,713

(22) Filed: Oct. 13, 2025

Related U.S. Application Data
(60) Provisional application No. 63/707,056, filed on Oct. 14, 2024.

(51) Int. Cl. G06Q 30/0242; G06Q 30/0241

(52) U.S. Cl. CPC G06Q 30/0246; G06Q 30/0277

(57) ABSTRACT

A computer-implemented method includes forecasting an estimated linear reach for a future ad campaign based at least in part on historical linear ad campaign data. The computer-implemented method also includes forecasting an estimated digital reach for the future ad campaign based at least in part on historical digital ad campaign data. The computer-implemented method also includes determining an estimated audience duplication based at least in part on the estimated linear reach and the estimated digital reach. The computer-implemented method also includes determining an estimated cross-platform reach based at least in part on the estimated linear reach, the estimated digital reach, and estimated audience duplication.

### CROSS-REFERENCE TO RELATED APPLICATIONS

This application claims priority to and the benefit of U.S. Provisional Application No. 63/707,056, entitled “SYSTEM AND METHOD FOR DETERMINING CROSS-PLATFORM REACH,” filed Oct. 14, 2024, which is incorporated by reference herein in its entirety for all purposes.

### BACKGROUND

The present disclosure relates generally to determining reach, such as (but not limited to) forecasting reach, for an ad campaign. More specifically, the present disclosure relates to determining reach for an ad campaign across multiple platforms, such as one or more linear platforms and one or more digital platforms.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Impressions and reach are important performance indicators for an ad campaign. For example, impressions indicate a number of times an ad is viewed during an ad campaign, while reach indicates a number of households (or people) that viewed the ad during the ad campaign. Because the ad might be viewed by the same household (or person) multiple times during the ad campaign, impressions are typically greater than reach. Calculating impressions and/or reach after completion of a prior ad campaign, including completed portions of an in-flight ad campaign, and forecasting impressions and/or reach for a future ad campaign, including future portions of an in-flight ad campaign, may be particularly helpful and informative to advertisers. For example, advertisers may use this information for ad campaign planning and/or negotiations.

Reach may be determined (e.g., forecasted, ascertained) for a single platform, such as a linear platform or a digital platform, based at least in part on impressions (e.g., forecasted impressions, actual impressions). For example, multiple impressions (e.g., forecasted impressions, actual impressions) corresponding to a common linear identifier (e.g., a common cable box ID) of a household or person can be de-duplicated in deriving linear reach (e.g., forecasted linear reach, actual linear reach). Likewise, multiple impressions (e.g., forecasted impressions, actual impressions) corresponding to a common digital identifier (e.g., a common device ID, a common IP address, etc.) of a household or person can be de-duplicated in deriving digital reach (e.g., forecasted digital reach, actual digital reach).

Determining cross-platform reach, such as (but not limited to) forecasting cross-platform reach, across multiple platforms (e.g., a linear platform and a digital platform) may be relatively complex compared to determining reach across a single platform (e.g., a linear platform or a digital platform). Indeed, the determined (e.g., forecasted, ascertained) cross-platform reach is not necessarily equal to a summation of the linear reach and the digital reach since a single household (or person) might be included in both categories. Traditional configurations are ill equipped for accurately determining an estimated cross-platform reach of an ad campaign, such as an actual cross-platform reach for a completed ad campaign and/or a forecasted cross-platform reach for a future ad campaign. Accordingly, it is now recognized that improved systems and methods for forecasting cross-platform reach are desired.

### BRIEF DESCRIPTION

Certain examples commensurate in scope with the originally claimed subject matter are summarized below. These examples are not intended to limit the scope of the claimed subject matter, but rather these examples are intended only to provide a brief summary of possible forms of the subject matter. Indeed, the subject matter may encompass a variety of forms that may be similar to or different from the examples set forth below.

In an aspect, a computer-implemented method includes forecasting an estimated linear reach for a future ad campaign based at least in part on historical linear ad campaign data. The computer-implemented method also includes forecasting an estimated digital reach for the future ad campaign based at least in part on historical digital ad campaign data. The computer-implemented method also includes determining an estimated audience duplication based at least in part on the estimated linear reach and the estimated digital reach. The computer-implemented method also includes determining an estimated cross-platform reach based at least in part on the estimated linear reach, the estimated digital reach, and the estimated audience duplication.

In another aspect, one or more tangible, non-transitory, computer readable media stores instructions thereon that, when executed by processing circuitry, are configured to cause the processing circuitry to perform various functions. The functions include forecasting an estimated linear reach for a future ad campaign based at least in part on historical linear ad campaign data. The functions also include forecasting an estimated digital reach for the future ad campaign based at least in part on historical digital ad campaign data. The functions also include determining an estimated audience duplication based at least in part on the estimated linear reach and the estimated digital reach. The functions also include determining an estimated cross-platform reach based at least in part on the estimated linear reach, the estimated digital reach, and the estimated audience duplication.

In still another aspect, a system includes at least one database storing historical linear ad campaign data and historical digital ad campaign data thereon, memory storing instructions thereon, and processing circuitry configured to execute the instructions to perform various functions. For example, the functions include receiving the historical linear ad campaign data from the at least one database, forecasting an estimated linear reach for a future ad campaign based at least in part on historical linear ad campaign data, receiving the historical digital ad campaign data from the at least one database, and forecasting an estimated digital reach for the future ad campaign based at least in part on historical digital ad campaign data. The functions also include determining an estimated audience duplication based at least in part on the estimated linear reach and the estimated digital reach. The functions also include determining an estimated cross-platform reach based at least in part on the estimated linear reach, the estimated digital reach, and the estimated audience duplication.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram illustrating a system configured to determine (e.g., forecast, ascertain) cross-platform reach for an ad campaign, in accordance with an aspect of the present disclosure;

FIG. 2 is a schematic illustration of a workflow implemented, for example, by the system of FIG. 1, including a linear reach determining (e.g., forecasting, ascertaining) procedure, a digital reach determining (e.g., forecasting, ascertaining) procedure, and a cross-platform reach determining (e.g., forecasting, ascertaining) procedure, in accordance with an aspect of the present disclosure;

FIG. 3 is a schematic illustration of a use case employing the cross-platform reach determining (e.g., forecasting, ascertaining) procedure of the workflow of FIG. 2, in accordance with an aspect of the present disclosure;

FIG. 4 is a schematic illustration of a panel scaling technique for the cross-platform reach determining (e.g., forecasting, ascertaining) procedure of the workflow of FIG. 2, in accordance with an aspect of the present disclosure;

FIG. 5 is a schematic illustration of a use case employing a Random Iterative Method (RIM) weighting technique for the cross-platform reach determining (e.g., forecasting, ascertaining) procedure of the workflow of FIG. 2, in accordance with an aspect of the present disclosure; and

FIG. 6 is a schematic illustration of dynamic estimation logic configured to select, in the cross-platform reach determining (e.g., forecasting, ascertaining) procedure of the workflow of FIG. 2, an audience duplication estimation technique from a plurality of estimation techniques based on error estimate data, in accordance with an aspect of the present disclosure;

FIG. 7 is a process flow diagram illustrating a computer-implemented method for determining (e.g., forecasting) cross-platform reach for an ad campaign using, for example, the system of FIG. 1 or a portion thereof, in accordance with an aspect of the present disclosure; and

FIG. 8 is a process flow diagram illustrating a computer-implemented method for determining cross-platform reach for an ad campaign, such as an actual cross-platform reach for a completed ad campaign or completed portions of an in-flight ad campaign, using, for example, the system of FIG. 1 or a portion thereof, in accordance with an aspect of the present disclosure.

### DETAILED DESCRIPTION

One or more specific examples of the present disclosure will be described below. In an effort to provide a concise description of these examples, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various examples of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure relates generally to determining, such as (but not limited to) forecasting, reach for an ad campaign. More specifically, the present disclosure relates to determining, such as (but not limited to) forecasting, reach for an ad campaign across multiple platforms, such as one or more linear platforms and one or more digital platforms. While certain examples described in detail below refer to forecasting reach for a planned ad campaign and/or a future portion of an in-flight ad campaign, it should be understood that certain of the same or similar techniques, such as (but not limited to) certain of the same or similar de-duplication and/or overlap estimation techniques, may be employed for ascertaining reach for a completed ad campaign and/or for a completed portion of an in-flight ad campaign. For example, reference to “determining” reach, such as cross-platform reach, (1) may include forecasting reach for a planned ad campaign and/or a future portion of an in-flight ad campaign, (2) may include ascertaining reach for a completed ad campaign and/or a completed portion of an in-flight ad campaign, or (3) may include both (1) and (2).

Impressions and reach are important performance indicators for an ad campaign. For example, impressions indicate a number of times an ad is viewed during an ad campaign, while reach indicates a number of households (or people) that view the ad during the ad campaign. In some aspects of the present disclosure, impressions and/or reach are limited to a target audience, such as an audience identified as being interested in a particular product, service, or other content. Because the ad might be viewed by the same household (or person) within the target audience multiple times during the ad campaign, impressions are typically greater than reach. For brevity, it should be understood that reference to “audience” means “target audience” herein. Calculating impressions and/or reach for a prior ad campaign (or a completed portion of an in-flight ad campaign) and forecasting impressions and/or reach for a future ad campaign (or for a future portion of an in-flight ad campaign) may be particularly informative to advertisers. It should be noted that “future ad campaign” and “planned ad campaign,” as used herein, may include an ad campaign that has not yet been initiated and/or may include future portions of an in-flight ad campaign. Further, “prior ad campaign” and “completed ad campaign,” as used herein, may include an ad campaign that has been completed and/or may include prior portions of an in-flight ad campaign. As previously described, while certain examples of the present disclosure refer to forecasting features, such as forecasting cross-platform reach for a future ad campaign, certain of the same or similar features (e.g., de-duplication techniques, overlap estimation techniques) may be employed for ascertaining cross-platform reach for a completed ad campaign or completed portions of an in-flight ad campaign.

Reach may be determined (e.g., forecasted, ascertained) for a single platform, such as a linear platform or a digital platform, based at least in part on impressions (e.g., forecasted impressions, actual impressions). For example, multiple impressions (e.g., forecasted impressions, actual impressions) corresponding to a common linear identifier (e.g., a common cable box ID) can be de-duplicated in deriving linear reach (e.g., forecasted linear reach, actual linear reach). Likewise, multiple impressions (e.g., forecasted impressions, actual impressions) corresponding to a common digital identifier (e.g., a common device ID, a common IP address, etc.) can be de-duplicated in deriving digital reach (e.g., forecasted digital reach, actual digital reach).

In contrast to single platform processing, forecasting or ascertaining reach across multiple platforms, such as a linear platform and a digital platform, may be relatively complex. Indeed, the forecasted or actual cross-platform reach is not necessarily equal to a summation of the forecasted or actual linear reach and the forecasted or actual digital reach since a single household (or person) might be included in both categories. As an example, if the forecasted or actual linear reach is equal to 1,000,000 and the forecasted or actual digital reach is equal to 630,000, the forecasted or actual cross-platform reach may substantially deviate from the summation of the forecasted or actual linear reach and the forecasted or actual digital reach, or 1,630,000, because certain households (or people) may be counted in both the forecasted or actual linear reach and the forecasted or actual digital reach. Systems, methods, and techniques in accordance with the present disclosure may seek to identify an audience duplication or overlap between the forecasted or actual linear reach and the forecasted or actual digital reach, where the forecasted or actual cross-platform reach is equal to the audience duplication or overlap subtracted from the summation of the forecasted or actual linear reach and the forecasted or actual digital reach. In the above-described example, if the audience duplication is 20,000, the forecasted or actual cross-platform reach would be 20,000 subtracted from 1,630,000, or 1,610,000. In this way, households (or people) counted in both the forecasted or actual linear reach and the forecasted or actual digital reach are de-duplicated to produce a more accurate estimate of the forecasted or actual cross-platform reach.

Estimating the audience duplication or overlap can be relatively complex based at least in part on a lack of information regarding linear identifiers (e.g., a cable box ID) and digital identifiers (e.g., a device ID, an IP address, etc.) belonging to the same household or person. That is, a nexus between each linear identifier and each digital identifier for at least some households or persons across the audience may not be known. However, such nexuses may be known for a sub-set of the audience, referred to herein as a panel. Presently disclosed examples may include an audience duplication estimation technique that scales such panel data to the audience, among other possible data processing. For example, the known data may include the estimated linear reach (e.g., of the audience), the estimated digital reach (e.g., of the audience), a linear panel reach, a digital panel reach, and a panel audience duplication. Such known information may be employed in a panel scaling technique, also referred to in certain instances of the present disclosure as a weighting technique, to determine (e.g., estimate) the audience duplication between the forecasted or actual linear reach of the audience and the forecasted or actual digital reach of the audience. One such panel scaling technique is referred to herein as the Random Iterative Method (RIM) weighting technique. Other techniques for determining the audience duplication, such as other panel scaling techniques (or weighting techniques), are also possible. In certain aspects, dynamic estimation logic may be employed to determine (e.g., select) a preferred audience duplication estimation technique from a plurality of audience duplication estimation techniques based on, for example, use case-specific error estimate data. The RIM weighting technique, the dynamic estimation logic, and other aspects of the present disclosure will be described in greater detail below with reference to the drawings.

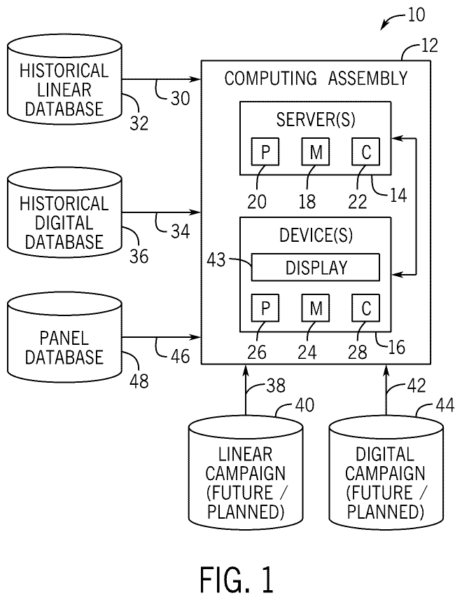

FIG. 1 is a block diagram illustrating a system 10 configured to determine cross-platform reach of a target audience, referred to for purposes of brevity below as an audience, for an ad campaign. While certain aspects of FIG. 1 are described in detail below in the context of forecasting cross-platform reach (e.g., forecasted cross-platform reach) of a target audience for a future ad campaign or future portions of an in-flight ad campaign, it should be understood that certain of the same or similar features, techniques, etc., such as certain of the same or similar de-duplication or overlap estimation features, techniques, etc., may be employed in the context of ascertaining cross-platform reach (e.g., actual cross-platform reach) of a completed ad campaign or completed portions of an in-flight ad campaign. In general, whether it relates to forecasted cross-platform reach or actual cross-platform reach, the system 10 may be configured to determine reach across multiple platforms, such as one or more linear platforms and one or more digital platforms. As previously described, “future ad campaign,” as used herein, may include an ad campaign that has not yet been initiated and/or future portions of an in-flight ad campaign, and “completed ad campaign,” as used herein, may include an ad campaign that has been completed and/or completed portions of an in-flight ad campaign.

In FIG. 1, the system 10 includes a computing assembly 12 having one or more servers 14 and one or more electronic devices 16 (e.g., one or more personal computers, laptops, tables, mobile devices, etc.). For brevity, the one or more servers 14 are referred to as the server 14 below, and the one or more electronic devices 16 are referred to as the electronic device 16 below. However, it should be understood that multiple instances of the server 14 and/or multiple instances of the electronic device 16 may be employed in the computing assembly 12. The server 14 includes memory circuitry 18 (e.g., one or more memories) storing instructions thereon, processing circuitry 20 (e.g., one or more processors) configured to execute the instructions to perform various functions, and communications circuitry 22 (e.g., one or more receivers, one or more transmitters, and/or one or more transceivers) configured to enable communication between the server 14 and other components of the system 10, such as the electronic device 16. Likewise, the electronic device 16 includes memory circuitry 24 (e.g., one or more memories) storing instructions thereon, processing circuitry 26 (e.g., one or more processors) configured to execute the instructions to perform various functions, and communications circuitry 28 (e.g., one or more receivers, one or more transmitters, and/or one or more transceivers) configured to enable communication between the electronic device 16 and other components of the system 10, such as the server 14.

The computing assembly 12 (e.g., the server 14, the electronic device 16, or both) may be configured to forecast cross-platform reach for an ad campaign (e.g., a future ad campaign), as previously described. In accordance with the present disclosure, the computing assembly 12 is configured to forecast the cross-platform reach based at least in part on historical data associated with one or more prior ad campaigns. For example, the computing assembly 12 may receive historical linear ad campaign data 30 associated with a prior ad campaign from a historical linear database 32 and historical digital ad campaign data 34 associated with a prior ad campaign from a historical digital database 36. In some aspects, the historical linear ad campaign data 30 and the historical digital ad campaign data 34 received by the computing assembly 12 correspond to a common prior ad campaign delivered on both linear and digital platforms. While the present disclosure refers to the historical linear database 32 and the historical digital database 36, it should be understood that “database” is used herein to refer to any data source from which the historical linear ad campaign data 30 and/or the historical digital ad campaign data 34 may be received, such as an ad server or other electronic device.

The historical linear ad campaign data 30 may include, for example, information indicative of various impressions, such as numbers of impressions that occurred on particular days at particular times (e.g., time sots) with respect to particular selling titles and/or particular properties (e.g., networks), among other possible information. The historical digital ad campaign data 34 may include, for example, information indicative of various impressions, such as a date and/or a time on which each impression occurred, a visitor ID (e.g., a device ID and/or device group) corresponding to each impression, a platform on which each impression occurred, and a vertical on which each impression occurred, among other possible information.

The computing assembly 12 also may be configured to receive linear campaign data 38 from a linear database 40 and digital campaign data 42 from a digital database 44. For example, the linear campaign data 38 may include information pertaining to the planned or future linear ad campaign and the digital campaign data 42 may include information pertaining to the planned or future digital ad campaign. The linear campaign data 38 and the digital campaign data 42 may correspond to a single planned or future ad campaign being executed on both linear and digital platforms, and may include various information corresponding to such planned or future ad campaign, such as content or run length of the ad, desired ad scheduling information, target audience information, etc. While the present disclosure refers to the linear database 40 and the digital database 44, it should be understood that “database” is used herein to refer to any data source from which the linear campaign data 38 and/or the digital campaign data 42 may be received, such as an ad server or other electronic device.

In some aspects of the present disclosure, the prior ad campaign(s) referenced above and corresponding to the historical linear ad campaign data 30 and the historical digital ad campaign data 34 may be selected based on one or more similarities between the prior ad campaign(s) and the future ad campaign(s) corresponding to the linear campaign data 38 and the digital campaign data 42. Such similarities may include, for example, one or more similarities in content, one or more similarities in the target audience, one or more similarities in other content delivery characteristics (e.g., dates, times, platforms), and/or one or more other similarities.

The computing assembly 12 may forecast estimated linear reach (e.g., linear household reach) of the future ad campaign based at least in part on the historical linear ad campaign data 30 via one or more processing steps, and the computing assembly 12 may forecast estimated digital reach (e.g., digital household reach) of the future ad campaign based at least in part on the historical digital ad campaign data 34 via one or more processing steps. The processing steps involved in forecasting the estimated linear reach and the estimated digital reach, described in greater detail with reference to later drawings, may include a forecasting step, a time series generation step, a de-duplication step, an aggregation step, a conversion step (e.g., a device to household conversion step and/or a household to device conversion step), and the like. While certain aspects of the present disclosure describe certain of the steps above in the context of forecasting reach (e.g., forecasting cross-platform reach), it should be understood that certain aspects of the present disclosure may include certain of the same or similar steps above, such as the de-duplication step, the aggregation step, and/or the conversion step, among other possible steps, in the context of ascertaining actual reach (e.g., actual cross-platform reach) for a completed ad campaign or completed portions of an in-flight ad campaign. In this way, the computing assembly 12 determines, for example, an estimated linear household (or device) reach and an estimated digital household (or device) reach, whether they are forecasted for a future ad campaign or ascertained for a completed ad campaign.

The computing assembly 12 may determine (e.g., forecast, ascertain) an estimated cross-platform reach as a function of the estimated linear household reach and the estimated digital household reach. However, the estimated cross-platform reach is not necessarily equal to a summation of the estimated linear household reach and the estimated digital household reach. Indeed, certain households (or people) may be counted in both the estimated linear household reach and the estimated digital household reach. In accordance with the present disclosure, the computing assembly 12 determines (e.g., estimates) an audience duplication between the estimated linear household reach and the estimated digital household reach, where the estimated cross-platform reach is equal to:

$${Reach}_{XP} = {Reach}_{Linear} + {Reach}_{Digital} - Audience\_Duplication \qquad Equation 1$$

In order to execute Equation 1 above, the computing assembly 12 may determine (e.g., estimate) the audience duplication. However, audience duplication may not necessarily be determinable simply by identifying commonalities between households (or people) in both the estimated linear household reach and the estimated digital household reach, since such commonalities may not be known for all households (or people) in the audience. For example, a nexus between a linear ID (e.g., a cable box ID) and a digital ID (e.g., a device ID, an IP address, etc.) may not be known for all households (or people) in the audience. In accordance with the present disclosure, panel data 46 corresponding to a sub-set (e.g., a panel) of the audience may be employed to determine (e.g., estimate) the audience duplication between the estimated linear household reach and the estimated digital household reach. For example, the panel data 46, which may be received by the computing assembly 12 from a panel database 48 (or other data source), may include a linear household reach of the panel (referred to in certain instances of the present disclosure as linear household panel reach), a digital household reach of the panel (referred to in certain instances of the present disclosure as digital household panel reach), and an audience duplication of the panel (referred to in certain instances of the present disclosure as panel audience duplication). It should be understood that “database” is used herein to refer to any data source from which the panel data 46 may be received, such as an ad server or other electronic device.

One or more panel scaling techniques may be employed to determine (e.g., estimate) the audience duplication between the estimated linear household reach and the estimated digital household reach. For example, the one or more panel scaling techniques may determine (e.g., estimate) the audience duplication based at least in part on known data, including the estimated linear household reach, the estimated digital household reach, the linear panel household reach, the digital panel household reach, and the panel audience duplication. The one or more panel scaling techniques may include, for example, a Random Iterative Method (RIM) weighting technique. Other audience duplication estimation techniques, including other panel scaling techniques, are also possible in accordance with the present disclosure. Such audience duplication estimation techniques will be described in greater detail with reference to later drawings.

After determining (e.g., estimating) the audience duplication, the computing assembly 12 may execute Equation 1 above. In some aspects, the computing assembly 12 determines a cross-platform household reach percentage (e.g., the estimated cross-platform household reach divided by a cross-platform household universe), a linear household reach percentage (e.g., the estimated linear household reach divided by the cross-platform household universe), and/or a digital household reach percentage (e.g., the estimated digital household reach divided by the cross-platform household universe). “Universe” as used herein may refer to all viewers, as opposed to “audience,” which is used herein to refer to a target audience (e.g., a sub-set of the universe that the advertiser of the future ad campaign is targeting). The cross-platform household universe may be, in certain examples, equal to the linear universe size.

The computing assembly 12, in accordance with the present disclosure, may output any and/or all of the various data and/or information described above to a display, such as a display 43 of the electronic device 16. In examples where the server 14 handles some or all of the processing described above with respect to FIG. 1 and in greater detail with respect to later drawings below, the server 14 may transmit (e.g., via the communications circuitry 22) various data outputs to the electrotonic device 16, and the electrotonic device 16 may receive (e.g., via the communications circuitry 28) such data outputs from the server 14 for presentation on the display 43 of the electrotonic device 16. In this way, advertisers and/or media entities can observe estimated reach indicators for planning and/or negotiating future ad campaigns. These and other aspects of the present disclosure are described in greater detail below with reference to later drawings.

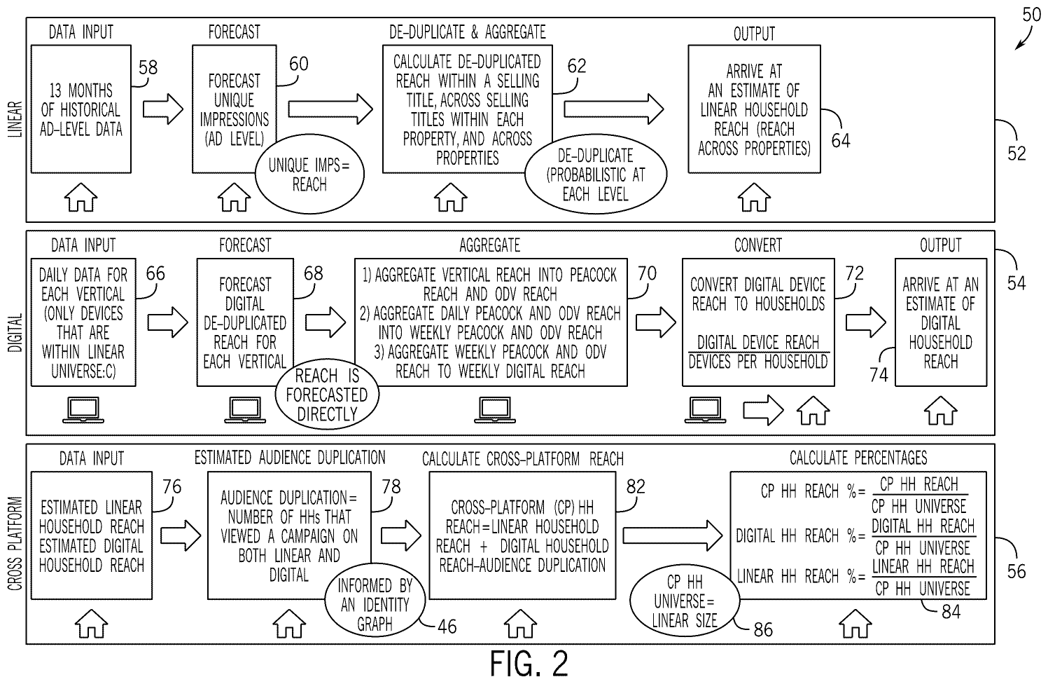

FIG. 2 is a schematic illustration of an example of a workflow 50 implemented, for example, by the system 10 of FIG. 1, including a linear reach determining (e.g., forecasting, ascertaining) procedure 52, a digital reach determining (e.g., forecasting, ascertaining) procedure 54, and a cross-platform reach determining (e.g., forecasting, ascertaining) procedure 56. Outputs from the linear reach determining procedure 52 and the digital reach determining procedure 54 may be employed, along with other possible information, in the cross-platform reach determining procedure 56 to determine (e.g., forecast, estimate) the cross-platform reach of a future ad campaign. While certain aspects of the description of FIG. 2 below pertain to forecasting data techniques for a planned ad campaign or future portions of an in-flight ad campaign, it should be understood that certain of the same or similar techniques may be employed for determining actual data of a completed ad campaign or completed portions of an in-flight ad campaign. For example, de-duplication and/or overlap estimation techniques may be employed for determining forecasted data and/or for determining actuals data.

Referring to FIG. 2, beginning with the linear reach determining procedure 52, block 58 represents one or more data inputs (e.g., linear data inputs) employed in the linear reach determining procedure 52. The data input(s) corresponding to block 58 may include, for example, the historical linear ad campaign data 30 described above with respect to FIG. 1. The linear reach determining procedure 52 includes forecasting (block 60) impressions (e.g., unique impressions), for example, at an ad unit level based on the data input(s) corresponding to block 58. That is, the forecasted impressions at the ad unit level may include information indicative of, for example, forecasted impressions at particular days and/or times (e.g., time slots) with respect to particular selling titles and/or particular properties (e.g., networks), among other possible information. The linear reach determining procedure 52 also includes de-duplicating and/or aggregating (block 62) the forecasted impressions (e.g., via a cascading computation) within each selling title, across selling titles within each property, and across all properties to determine a total estimated linear household reach output at block 64. De-duplication, as previously described, may include identifying a common household identifier (e.g., a common cable box ID) across multiple impressions (e.g., forecasted impressions) to determine the total estimated linear household reach.

Turning to the digital reach determining procedure 54, block 66 represents one or more data inputs (e.g., digital data inputs) employed in the digital reach determining procedure 54. The data input(s) corresponding to block 66 may include, for example, the historical digital ad campaign data 34 described above with respect to FIG. 1. The digital reach determining procedure 54 includes forecasting (block 68) and aggregating (block 70) to determine digital device reach based at least in part on the data input(s) corresponding to block 66. Block 68 and/or block 70 may include, for example, aggregating daily viewership based on the data input(s) corresponding to block 66 (e.g., in platform-vertical-form-device group combinations), generating a time series across various days based on the aggregated daily viewership, and forecasting digital device reach based on the time series. In this way, the output from blocks 68 and 70 corresponds to an estimated digital device reach. As previously described, the linear reach determining procedure 54 outputs the estimated linear household reach at block 64, which is in a different form (e.g., households) than the estimated digital device reach (e.g., devices) output, for example, from block 70. Indeed, a single household may include multiple devices. Accordingly, the digital reach determining procedure 54 includes converting (block 72) the estimated digital device reach to an estimated digital household reach. In some examples, the estimated digital device reach is divided at the conversion step of block 72 by a factor or variable corresponding to an estimate of the number of devices per household in the audience, such as 1.5 devices, 2 devices, 3 devices, or the like. In this way, the digital reach determining procedure 54 outputs, at block 74, an estimated digital household reach having a common form (e.g., households) as the estimated linear household reach from the linear reach determining procedure 52. In other aspects, conversion may instead occur in the linear reach determining procedure 52, namely, the estimated linear household reach may be converted to an estimated linear device reach such that the estimated linear device reach has a common form (e.g., devices) as the estimated digital device reach output from block 70.

Continuing with the cross-platform reach determining procedure 56, at block 76, it receives the output from block 64 of the linear reach determining procedure 52 (e.g., the estimated linear household reach) and the output from block 74 of the digital reach determining procedure 54 (e.g., the estimated digital household reach). As shown, the cross-platform reach determining procedure 56 includes determining (block 78) an audience duplication between the estimated linear household reach and the estimated digital household reach. Determining the audience duplication at block 78 may be based at least in part on an identity graph corresponding, for example, to the panel data 46 described above with respect to FIG. 1. The identity graph may be employed in an audience duplication estimation technique, such as a panel scaling technique. One such panel scaling technique is briefly described above with respect to FIG. 1, and described in greater detail below (along with other possible audience duplication estimation techniques, such as other possible panel scaling techniques) with reference to later drawings. The cross-platform reach determining procedure 56 also includes determining (block 82) the cross-platform household reach based, for example, on the data inputs at block 76 (e.g., the estimated linear household reach from block 64 of the linear reach determining procedure 52 and the estimated digital household reach from block 74 of the digital reach determining procedure 54) and the estimated audience duplication from block 78. For example, as previously described with respect to Equation 1 above, the estimated cross-platform reach is equal to the estimated audience duplication subtracted from a summation of the estimated linear household reach and the estimated digital household reach. The cross-platform reach determining procedure 56 may also include determining (block 84) various reach percentages, such as the cross-platform household reach percentage (e.g., the estimated cross-platform household reach divided by the cross-platform household universe), the linear household reach percentage (e.g., the estimated linear household reach divided by the cross-platform household universe), and/or the digital household reach percentage (e.g., the estimated digital household reach divided by the cross-platform household universe). As previously described and indicated by block 86 in FIG. 2, the cross-platform household universe may be equal to the linear universe size in certain aspects.

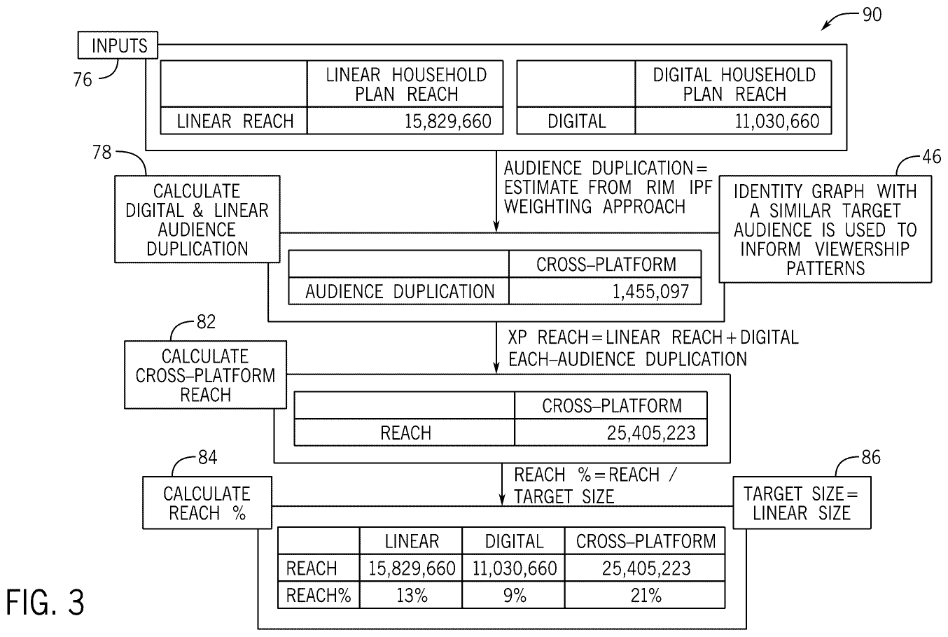

FIG. 3 is a schematic illustration of an example use case 90 employing the cross-platform reach determining procedure 56 of the workflow 50 of FIG. 2, including blocks 76, 78, 82, 84, and 86 and the identity graph (e.g., panel data 46), described above. In the illustrated example, the data inputs corresponding to block 76 include an estimated linear household reach of 15,829,660 and an estimated digital household reach of 11,030,066. Further, the estimated audience duplication at block 78 is 1,455,097. As shown, an identity graph (also referred to as, or otherwise derived from, the panel data 46) corresponding, for example, to a panel (e.g., a sub-set) of the audience, described in greater detail with reference to later drawings, is employed in a panel scaling technique to inform viewership patterns for determining the estimated audience duplication at block 78. The estimated cross-platform reach (e.g., 25,404,629) is determined at block 82 by subtracting, in accordance with Equation 1 above, the estimated audience duplication (e.g., 1,455,097) from a summation of the estimated linear household reach (e.g., 15,829,660) and the estimated digital household reach (e.g., 11,030,066). Further, the estimated reach percentages are determined at block 84, as previously described, based on the target size (e.g., linear size, also referred to as the cross-platform universe) being equal to approximately 120,000,000. Thus, the cross-platform household reach percentage (e.g., the estimated cross-platform household reach, or 25,404,629, divided by the target size, or 120,000,000) is approximately 21%, the linear household reach percentage (e.g., the estimated linear household reach, or 15,829,660, divided by the target size, or 120,000,000) is approximately 13%, and the digital household reach percentage (e.g., the estimated digital household reach, or 11,030,660, divided by the target size, or 120,000,000) is approximately 9%.

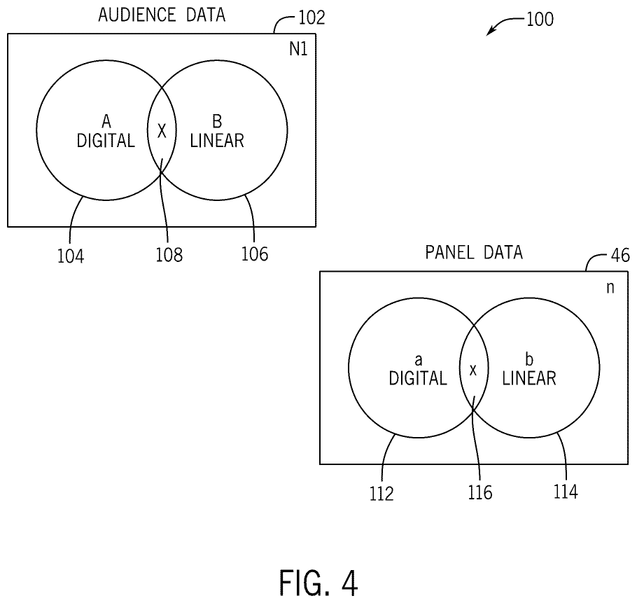

FIG. 4 is a schematic illustration of a panel scaling technique 100 for the cross-platform reach determining procedure 56 of the workflow 50 of FIG. 2. That is, the panel scaling technique 100 in FIG. 4 may be employed at block 78 of FIG. 2. In the illustrated example, audience data 102 includes an estimated digital household reach 104 (A) and an estimated linear household reach 106 (B). While the estimated digital household reach 104 and the estimated linear household reach 106 are derived as previously described, an estimated audience duplication 108 (X) (e.g., estimated forecasted audience duplication, estimated actual audience duplication), also referred to as an audience overlap, between the estimated digital household reach 104 and the estimated linear household reach 106 is unknown. The panel data 46 corresponding to the panel (e.g., the sub-set of the audience) includes a digital household panel reach 112 (a), a linear household panel reach 114 (b), and a panel audience duplication 116 (x) there between, all of which are known. In some aspects, the audience data 102 and/or the panel data 46 may include additional information, such as information indicating members of the target audience that did not view (or are not forecasted to view) an advertisement during an ad campaign. As shown in the visual representation of the panel scaling technique 100 in FIG. 4, the panel data 46 may be scaled to the audience data 102 to determine the estimated audience duplication 108 (X). More specific aspects of scaling and/or other audience duplication estimation techniques are described in detail below with reference to later drawings.

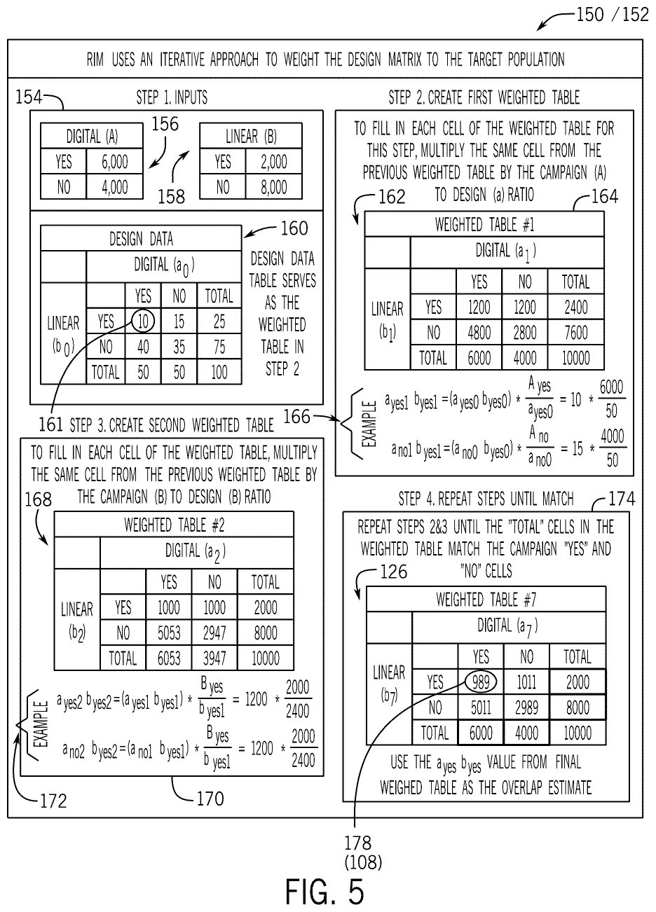

FIG. 5 is a schematic illustration of an exemplary use case 150 employing a Random Iterative Method (RIM) weighting technique 152 for the cross-platform reach determining procedure 56 of the workflow 50 of FIG. 2. In the illustrated example, the RIM weighting technique 152 includes a first step 154 of gathering data inputs and/or arranging the data inputs into various matrices (or data sets). For example, the data inputs are arranged in a first matrix 156 (A), a second matrix 158 (B), and a third matrix 160. The first matrix 156 corresponds to digital campaign information or data (also referred to as digital audience information or data), including members of the audience that are included in the estimated digital household reach (“Yes”) and are not included in the estimated digital household reach (“No”). That is, the first matrix 156 includes a first cell (Aves) corresponding to the members of the audience included in the estimated digital household reach (e.g., 6,000) and a second cell (Ano) corresponding to the members of the audience not included in the estimated digital household reach (e.g., 4,000). The second matrix 158 corresponds to linear campaign information or data (also referred to as linear audience information or data), including members of the audience that are included in the estimated linear household reach (“Yes”) and are not included in the estimated linear household reach (“No”). That is, the second matrix 158 includes a first cell (Byes) corresponding to members of the audience included in the estimated linear household reach (e.g., 2,000) and a second cell (Bₙₒ) corresponding to members of the audience not included in the estimated linear household reach (e.g., 8,000).

The third matrix 160 corresponds to panel information or data (also referred to as design information or data), including panel digital household information (a₀) and panel linear household information (b₀), such as members of the panel that are included in the panel digital household reach and included in the panel linear household reach (“Yes” and “Yes”), members of the panel that are included in the panel digital household reach and not in the panel linear household reach (“Yes” and “No”), members of the panel that are not included in the panel digital household reach and are included in the panel digital household reach (“No” and “Yes”), and members of the panel that are included in neither the panel digital household reach nor the panel linear household reach (“No” and “No”), and totals thereof. That is, the third matrix 160 includes at least a first cell (a_{yes0}b_{yes0}) corresponding to members of the panel included in both the panel digital household reach and the panel linear household reach (e.g., 10), a second cell (a_{yes0}bₙₒ₀) corresponding to members of the panel included in the panel digital household reach and not in the panel linear household reach (e.g., 40), a third cell (aₙₒ₀b_{yes0}) corresponding to members of the panel that are not included in the panel digital household reach and are included in the panel digital household reach (e.g., 15), a fourth cell (aₙₒ₀bₙₒ₀) corresponding to members of the panel that are included in neither of the panel digital household reach nor the panel linear household reach (e.g., 35), and cells totaling rows and columns of the above-described cells. In the illustrated example, the panel cross-platform reach (x) is known and equal to 10, as shown in cell block 161 (i.e., a_{yes0}b_{yes0}).

The third matrix 160 is employed to generate a weighted table 162 in a second step 164 of the RIM weighting technique 152, as shown. For example, each cell in the third matrix 160 from the first step 154 is multiplied by a respective ratio between linear audience data (A) from the first matrix 156 and linear panel data (a₀) from the third matrix 160, as illustrated in the examples 166 in the second step 164 of the RIM weighting technique 152 in FIG. 5. In this way, the weighted table 162 in the second step 164 of the RIM weighting technique 152 includes at least a first cell (a_{yes1}b_{yes1}), which equals 1,200 in the illustrated example, a second cell (a_{yes1}bₙₒ₁), which equals 4,800 in the illustrated example, a third cell (aₙₒ₁b_{yes1}), which equals 1,200 in the illustrated example, a fourth cell (aₙₒ₁bₙₒ₁), which equals 2,800 in the illustrated example, and cells totaling rows and columns of the above-described cells.

The weighted table 162 illustrated in the second step 164 of the RIM weighting technique 152 is then used to generate an additional weighted table 168 in a third step 170 of the RIM weighting technique 152, as shown. For example, each cell in the weighted table 162 from the second step 164 is multiplied by a respective ratio between digital audience data (B) from the second matrix 158 and weighted digital panel data (b₁) from the weighted table 162, as illustrated in the examples 172 in the third step 170 of the RIM weighting technique 152 in FIG. 5. In this way, the additional weighted table 168 in the third step 170 of the RIM weighting technique 152 includes at least a first cell (a_{yes2}b_{yes2}), which equals 1,000 in the illustrated example, a second cell (a_{yes2}bₙₒ₂), which equals 5,053 in the illustrated example, a third cell (aₙₒ₂b_{yes2}), which equals 1,000 in the illustrated example, a fourth cell (aₙₒ₂bₙₒ₂), which equals 2,947 in the illustrated example, and cells totaling rows and columns of the above-described cells.

The second step 164 and the third step 170 are repeated until a final step 174 in which the totals in a final table 176 of the final step 174 correspond to (e.g., match) the data included in the first matrix 156 and the second matrix 158 of the first step 154, as shown. A cell 178 in the final table 176 corresponding to “Yes” for linear and “Yes” for digital, or a_{yes7}b_{yes7} in the illustrated example, indicates the estimated audience duplication 108 (e.g., 989), also referred to as estimated audience overlap, of the audience.

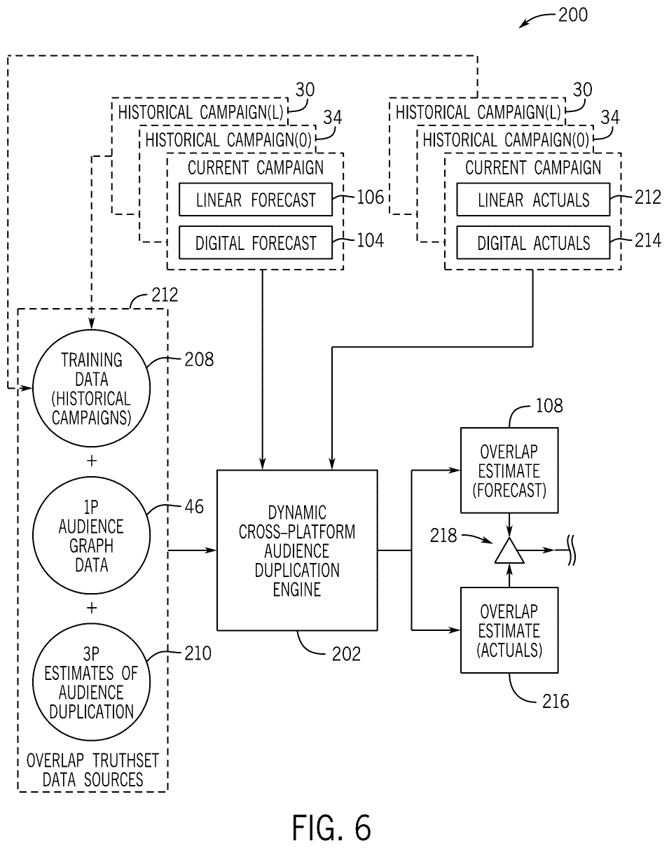

FIG. 6 is a schematic illustration of an exemplary dynamic estimation logic 200 configured to select, in the cross-platform reach determining procedure 56 of the workflow 50 of FIG. 2, an audience duplication estimation technique from a plurality of estimation techniques based on error estimate data, and then determine the estimated audience duplication based at least in part on the selected audience duplication estimation technique. In the illustrated example, the dynamic estimation logic 200 includes a dynamic campaign overlap estimator 202 configured to receive historical campaign data, including the historical linear ad campaign data 30 and the historical digital ad campaign data 34. The historical linear ad campaign data 30 may include, for example, forecasted data (e.g., forecasted reach data) corresponding to prior ad campaigns and/or actual or measured data (e.g., actual or measured reach data) corresponding to prior ad campaigns. The dynamic campaign overlap estimator 202 may also receive, as shown, some or all data from a truthset data source 212. The data from the truthset data source 212 may include, for example, training data 208, third party data 210, and/or the panel data 46, also referred to as audience graph and/or identify graph, previously described with respect to earlier drawings, such as FIG. 4. The training data 208 may be derived from, or a function of, the historical campaign data 30, 34 as shown. The third party data 210 may include, for example, survey data (e.g., proxy estimations from omnibus surveys), published research on cross-platform audience duplication, or other third party data. As described in greater detail below, the dynamic campaign overlap estimator 202 may dynamically select and/or prioritize certain data from the thruthset data source 212 to more accurately determine the forecasted overlap estimate 108 and/or an actual overlap estimate 216 (described in greater detail below).

In the illustrated example, the dynamic campaign overlap estimator 202 also may receive the estimated digital household reach 104 and the estimated linear household reach 106, among other possible information (e.g., other data indicative of a linear and/or digital ad campaign, such as the linear campaign data 38 and/or the digital campaign data 42 described above with respect to earlier drawings). Based at least in part on the historical ad campaign data 30, 34, some or all of the data from the truthset data source 212 (e.g., the training data 208, the panel data 46, the third party data 210, or any combination thereof), the estimated digital household reach 104, the estimated linear household reach 106, or any combination thereof, the dynamic campaign overlap estimator 202 may select an audience duplication (or overlap) estimation technique from a variety of audience duplication (or overlap) estimation techniques. As previously described, one such technique is Random Iterative Method (RIM) weighting. Other possible estimation techniques may include, but are not limited to, a canonical expansion model technique, a random duplication model technique, a maximum likelihood approach with a closed-form estimator for duplication technique, an effective signature approach technique, a modeling multivariate distribution using copulas technique, and a weighted projection model technique.

In certain examples, the dynamic campaign overlap estimator 202 determines error estimates corresponding to each of the above-described available estimation techniques and, based on the error estimate data, selects an estimation technique from the available estimation techniques. The dynamic campaign overlap estimator 202 may select and/or prioritize some or all of the data from the truthset data source 212 (e.g., from the training data 208, the third party data 210, and/or the panel data 46) based on an availability of such data, a comprehensiveness of such data, a performance of prior evaluations employing such data, or the like, in determining error estimates for the available estimation techniques. For example, the dynamic campaign overlap estimator 202 may select the estimation technique having the lowest error range of all available estimation techniques in certain examples. Because the error estimates may be dependent on one or more of the above-described data inputs 30, 34, 38, 104, 106 to the dynamic campaign overlap estimator 202, the overlap estimation technique(s) selected by the dynamic campaign overlap estimator 202 may vary by campaign.

In some aspects of the present disclosure, the dynamic campaign overlap estimator 202 may determine a first preferred estimation technique based on error estimates determined in view of the training data 208, a second preferred estimation technique based on error estimates determined in view of the panel data 46, and/or a third preferred estimation technique based on error estimates determined in view of the third party data 210. The first preferred estimation technique may be the same as or different than the second preferred estimation technique and/or the third preferred estimation technique. If the first and second preferred estimation techniques correspond to a common estimation technique, the dynamic campaign overlap estimator 202 may employ such common overlap estimation technique (e.g., as opposed to the third preferred estimation technique). Additionally or alternatively, the dynamic campaign overlap estimator 202 may determine multiple iterations of the forecasted overlap estimate 108 and/or the actual overlap estimate 216, such as three iterations of the forecasted overlap estimate 108 and/or the actual overlap estimate 216, based on different data from the thruthset data source 212, such as the three sources (e.g., the training data 2018, the third party data 210, and the panel data 46) illustrated in FIG. 6. In some aspects of the present disclosure, if multiple iterations of the forecasted overlap estimate 108 and/or the actual overlap estimate 216 are determined, an average, median, or other mathematical derivation may be employed to output singular estimates therefrom. Other techniques for dynamically selecting various data by way of the dynamic campaign overlap estimator 202 to determine the preferred estimation technique(s) and/or to determine the forecasted overlap estimate 108 and/or the actual overlap estimate 216 by way of the preferred estimation technique(s) are also possible in accordance with the present disclosure.

After selecting the audience duplication (or overlap) estimation technique as outlined above, the dynamic campaign overlap estimator 202 may determine and output the estimated forecasted audience duplication 108 based on (e.g., using) the selected estimation technique, also referred to as an estimated audience overlap, between the estimated digital household reach 104 and the estimated linear household reach 106, as shown.

In certain examples of the dynamic estimation logic 200, the dynamic campaign overlap estimator 202 also determines estimated actual (or measured) data, such as an estimated actual (or measured) audience overlap, after the planned or future ad campaign has been executed. For example, the dynamic campaign overlap estimator 202 may receive data indicative of actual linear reach 212 of the ad campaign and actual digital reach 214 of the ad campaign. The dynamic campaign overlap estimator 202 may employ any of the data described above with respect to FIG. 6, including but not limited to the truthset data source 212 (e.g., the training data 208, the panel data 46, the third party data 210, or any combination thereof), to determine the estimated actual audience duplication 216 (or overlap) between the actual linear reach 212 and the actual digital reach 214 of the ad campaign.

Further still, in certain examples, the dynamic estimation logic 200 (e.g., the dynamic campaign overlap estimator 202) determines a delta 218 between the estimated forecasted audience duplication 108 and the estimated actual audience duplication 216. The delta 218 may correspond at least in part to the error estimate data referenced above. In some examples, the delta 218 (or error estimate data) is captured in the training data 208 referenced above, or some other data source of the dynamic estimation logic 200. Accordingly, information indicative of the delta 218 (along with the estimation technique selected by the dynamic campaign overlap estimator 202 and/or other possible information) may be employed in subsequent forecasting iterations to improve subsequent selections of audience duplication (or overlap) techniques. In this way, the dynamic estimation logic 200 may employ machine learning to improve audience duplication technique selection over time and, thus, an accuracy of the estimated forecasted audience duplication 108 over time.

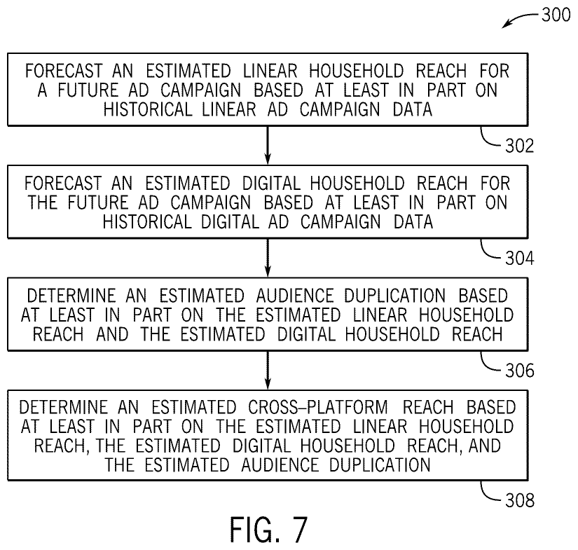

FIG. 7 is a process flow diagram illustrating an example of a computer-implemented method 300 for determining (e.g., forecasting) cross-platform reach for an ad campaign using, for example, the system 10 of FIG. 1 or a portion thereof. While the method 300 may be performed in an order corresponding to the order of the steps illustrated in FIG. 7 and described in detail below, it should be understood that the method 300 may be performed in other suitable orders. Further, while the method 300 may include only the steps illustrated in FIG. 7 and described in detail below, certain examples of the method 300 may include other steps in accordance with the present disclosure. Further still, certain steps of the method 300 illustrated in FIG. 7 and described in detail below may be excluded from certain examples of the method 300 in accordance with the present disclosure. In general, FIG. 7 is merely one example of the method 300 and should be not taken as representative of all examples of the method 300.

In the illustrated example, the method 300 includes forecasting (block 302) an estimated linear household reach for a future ad campaign based at least in part on historical linear ad campaign data. The historical linear ad campaign data may, in some examples, correspond to one or more prior ad campaigns having one or more similarities with the future ad campaign, as previously described. In some aspects, forecasting the estimated linear household reach includes forecasting an estimated linear household impressions based on the historical linear ad campaign data, and then de-duplicating and/or aggregating the estimated linear household impressions to derive the estimated linear household reach.

The method 300 also includes forecasting (block 304) an estimated digital household reach for the future ad campaign based at least in part on historical digital ad campaign data. The historical digital ad campaign data may, in some examples, correspond to one or more prior ad campaigns having one or more similarities with the future ad campaign, as previously described. Additionally or alternatively, the historical linear ad campaign data and the historical digital ad campaign may correspond to the same or similar prior ad campaign(s) (e.g., at least one prior ad campaign executed on both a linear platform and a digital platform). In some aspects, the historical digital ad campaign data is employed to forecast an estimated digital device reach, which is then converted to the estimated digital household reach. For example, the estimated digital device reach may be divided by an estimated number of devices per household to derive the estimated digital household reach. Additionally or alternatively, in some aspects, forecasting the estimated digital household reach includes forecasting an estimated digital household or device impressions based on the historical digital ad campaign data, and then de-duplicating, aggregating, and/or converting the estimated digital household impressions to derive the estimated digital household reach.

The method 300 also includes determining (block 306) an estimated audience duplication (or overlap) based at least in part on the estimated linear household reach and the estimated digital household reach. For example, because one or more households may be counted in both the estimated linear household reach and the estimated digital household reach, an estimated cross-platform reach may not necessarily be equal to a mere summation of the estimated linear household reach and the estimated digital household reach. Accordingly, the method 300 includes determining the estimated audience duplication at block 306 to effectively de-duplicate instances where one or more households are counted in both categories. Various techniques may be employed for determining the estimated audience duplication, such as various panel scaling techniques (e.g., a Random Iterative Method or “RIM” weighting technique). In some aspects, multiple techniques for determining the estimated audience duplication are available, and the method 300 includes selecting at least one of the multiple techniques (e.g., based on error estimate data).

The method 300 also includes determining (block 308) an estimated cross-platform reach based at least in part on the estimated linear household reach, the estimated digital household reach, and the estimated audience duplication. For example, as previously described with respect to Equation 1 above, the estimated cross-platform reach may be calculated by subtracting the estimated audience duplication from a summation of the estimated linear household reach and the estimated digital household reach.

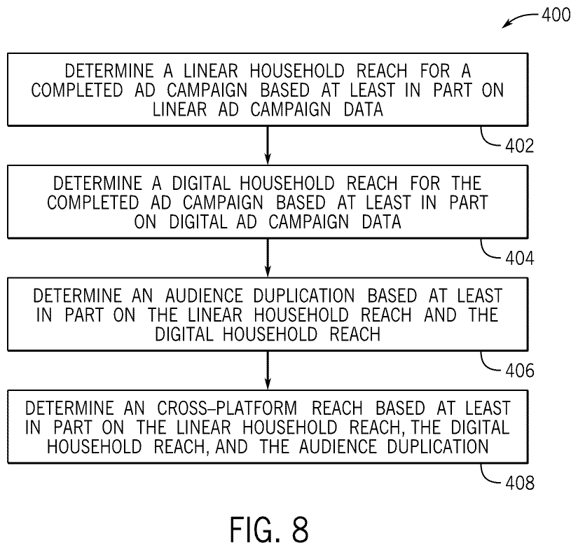

FIG. 8 is a process flow diagram illustrating a computer-implemented method 400 for determining cross-platform reach for an ad campaign, such as an actual cross-platform reach for a completed ad campaign or completed portions of an in-flight ad campaign, using, for example, the system of FIG. 1 or a portion thereof. While the method 400 may be performed in an order corresponding to the order of the steps illustrated in FIG. 8 and described in detail below, it should be understood that the method 400 may be performed in other suitable orders. Further, while the method 400 may include only the steps illustrated in FIG. 8 and described in detail below, certain examples of the method 400 may include other steps in accordance with the present disclosure. Further still, certain steps of the method 400 illustrated in FIG. 8 and described in detail below may be excluded from certain examples of the method 400 in accordance with the present disclosure. In general, FIG. 8 is merely one example of the method 400 and should be not taken as representative of all examples of the method 400.

In the illustrated example, the method 400 includes determining (block 402) a linear household reach (e.g., an estimated linear household reach) for a completed ad campaign based at least in part on linear ad campaign data. As previously described, “completed ad campaign” may include, in certain aspects of the present disclosure, a completed portion of an in-flight ad campaign. In certain examples, the linear household reach is determined by de-duplicating linear household impressions, as previously described. In the illustrated example, the method 400 also includes determining (block 404) a digital household reach (e.g., an estimated digital household reach) for the completed ad campaign based at least in part on digital ad campaign data. In certain examples, the linear household reach is determined by de-duplicating linear household impressions, as previously described.

In the illustrated example, the method 400 also includes determining (block 406) an audience duplication (e.g., an estimated audience duplication), also referred to as an audience overlap (e.g., an estimated audience overlap), based at least in part on the linear household reach and the digital household reach. For example, because one or more households may be counted in both the linear household reach and the digital household reach, a cross-platform reach may not necessarily be equal to a mere summation of the linear household reach and the digital household reach. Accordingly, the method 400 includes determining the estimated audience duplication at block 406 to effectively de-duplicate instances where one or more households are counted in both categories. Various techniques may be employed for determining the audience duplication, such as various panel scaling techniques (e.g., a Random Iterative Method or “RIM” weighting technique). In some aspects, multiple techniques for determining the estimated audience duplication are available, and the method 400 includes selecting at least one of the multiple techniques (e.g., based on error estimate data), as previously described.

In the illustrated example, the method 400 also includes determining (block 408) a cross-platform reach based at least in part on the linear household reach, the digital household reach, and the audience duplication (or overlap). For example, as previously described with respect to Equation 1 above, the cross-platform reach may be calculated by subtracting the audience duplication from a summation of the linear household reach and the digital household reach.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A computer-implemented method, comprising:
forecasting an estimated linear reach for a future ad campaign based at least in part on historical linear ad campaign data;
forecasting an estimated digital reach for the future ad campaign based at least in part on historical digital ad campaign data;
determining an estimated audience duplication based at least in part on the estimated linear reach and the estimated digital reach; and
determining an estimated cross-platform reach based at least in part on the estimated linear reach, the estimated digital reach, and the estimated audience duplication.

2. The computer-implemented method of claim 1, comprising determining the estimated audience duplication based at least in part on the estimated linear reach and the estimated digital reach via a Random Iterative Method (RIM) weighting technique in which a panel matrix is scaled to an audience matrix to solve for the estimated audience duplication.

3. The computer-implemented method of claim 2, wherein:
the panel matrix comprises a linear panel reach, a digital panel reach, and a panel audience duplication; and
the audience matrix comprises the estimated linear reach and the estimated digital reach.

4. The computer-implemented method of claim 1, comprising determining the estimated audience duplication based at least in part on the estimated linear reach and the estimated digital reach via dynamic estimation logic configured to:
select an estimation technique from a plurality of estimation techniques based on error estimate data; and
determine the estimated audience duplication based on the estimation technique.

5. The computer-implemented method of claim 4, wherein the plurality of estimation techniques comprises at least two of:
a Random Iterative Method (RIM) weighting technique;
a canonical expansion model technique;
a maximum likelihood approach with a closed-form estimator for duplication technique;
an effective signature approach technique;
a modeling multivariate distributions using copulas technique; or
a weighted projection model technique.

6. The computer-implemented method of claim 1, comprising determining the estimated cross-platform reach by subtracting the audience duplication from a summation of the estimated linear reach and the estimated digital reach.

7. The computer-implemented method of claim 1, comprising forecasting the estimated digital reach for the future ad campaign based at least in part on the historical digital ad campaign data by:
determining an estimated digital device reach based at least in part on the historical digital ad campaign data; and
dividing the estimated digital device reach by an estimated number of devices per household or person.

8. The computer-implemented method of claim 1, comprising forecasting the estimated linear reach for the future ad campaign based at least in part on the historical linear ad campaign data by:
forecasting an estimated linear impressions for the future ad campaign based at least in part on the historical linear ad campaign data; and
determining the estimated linear reach based at least in part on the estimated linear impressions.

9. One or more tangible, non-transitory, computer readable media storing instructions thereon that, when executed by processing circuitry, are configured to cause the processing circuitry to:
forecast an estimated linear reach for a future ad campaign based at least in part on historical linear ad campaign data;
forecast an estimated digital reach for the future ad campaign based at least in part on historical digital ad campaign data;
determine an estimated audience duplication based at least in part on the estimated linear reach and the estimated digital reach; and
determine an estimated cross-platform reach based at least in part on the estimated linear reach, the estimated digital reach, and the estimated audience duplication.

10. The one or more tangible, non-transitory, computer readable media of claim 9, wherein the instructions, when executed by the processing circuitry, are configured to cause the processing circuitry to determine the estimated audience duplication based at least in part on the estimated linear reach and the estimated digital reach via a Random Iterative Method (RIM) weighting technique in which a panel matrix is scaled to an audience matrix to solve for the estimated audience duplication.

11. The one or more tangible, non-transitory, computer readable media of claim 10, wherein:
the panel matrix comprises a linear panel reach, a digital panel reach, and a panel audience duplication; and
the audience matrix comprises the estimated linear reach and the estimated digital reach.

12. The one or more tangible, non-transitory, computer readable media of claim 9,
wherein the instructions, when executed by the processing circuitry, are configured to cause the processing circuitry to determine the estimated cross-platform reach by subtracting the audience duplication from a summation of the estimated linear reach and the estimated digital reach.

13. The one or more tangible, non-transitory, computer readable media of claim 9, wherein the instructions, when executed by the processing circuitry, are configured to cause the processing circuitry to:
determine an estimated cross-platform reach percentage by dividing the estimated cross-platform reach by a cross-platform universe;
determine an estimated linear reach percentage by dividing the estimated linear reach by the cross-platform universe; and
determine an estimated digital reach percentage by dividing the estimated digital reach by the cross-platform universe.

14. The one or more tangible, non-transitory, computer readable media of claim 9, wherein the instructions, when executed by the processing circuitry, are configured to cause the processing circuitry to forecast the estimated digital reach for the future ad campaign based at least in part on the historical digital ad campaign data by:
determining an estimated digital device reach based at least in part on the historical digital ad campaign data; and
dividing the estimated digital device reach by an estimated number of devices per household or person.

15. The one or more tangible, non-transitory, computer readable media of claim 9, wherein the instructions, when executed by the processing circuitry, are configured to cause the processing circuitry to forecast the estimated linear reach for the future ad campaign based at least in part on the historical linear ad campaign data by:
forecasting an estimated linear impressions for the future ad campaign based at least in part on the historical linear ad campaign data; and
determining the estimated linear reach based at least in part on the estimated linear impressions.

16. A system, comprising:
at least one database storing historical linear ad campaign data and historical digital ad campaign data thereon;
memory storing instructions thereon; and
processing circuitry configured to execute the instructions to:
receive the historical linear ad campaign data from the at least one database;
forecast an estimated linear reach for a future ad campaign based at least in part on historical linear ad campaign data;
receive the historical digital ad campaign data from the at least one database;
forecast an estimated digital reach for the future ad campaign based at least in part on historical digital ad campaign data;
determine an estimated audience duplication based at least in part on the estimated linear reach and the estimated digital reach; and
determine an estimated cross-platform reach based at least in part on the estimated linear reach, the estimated digital reach, and the estimated audience duplication.

17. The system of claim 16, wherein the processing circuitry is configured to execute the instructions to determine the estimated audience duplication based at least in part on the estimated linear reach and the estimated digital reach via a Random Iterative Method (RIM) weighting technique in which a panel matrix is scaled to an audience matrix to solve for the estimated audience duplication.

18. The system of claim 16, wherein the processing circuitry is configured to execute the instructions to determine the estimated audience duplication based at least in part on the estimated linear reach and the estimated digital reach via dynamic estimation logic configured to:
select an estimation technique from a plurality of estimation techniques based on error estimate data; and
determine the estimated audience duplication based on the estimation technique.

19. The system of claim 16, wherein the processing circuitry is configured to execute the instructions to:
determine an estimated cross-platform reach percentage by dividing the estimated cross-platform reach by a cross-platform universe;
determine an estimated linear reach percentage by dividing the estimated linear reach by the cross-platform universe; and
determine an estimated digital reach percentage by dividing the estimated digital reach by the cross-platform universe.

20. The system of claim 16, wherein the processing circuitry is configured to execute the instructions to forecast the estimated digital reach for the future ad campaign based at least in part on the historical digital ad campaign data by:
determining an estimated digital device reach based at least in part on the historical digital ad campaign data; and
dividing the estimated digital device reach by an estimated number of devices per household or person.
